(19) United States
(12) Patent Application Publication
(10) Pub. No.: US 2017/0212767 A1
(43) Pub. Date: Jul. 27, 2017

(54) METHOD AND DEVICE FOR TRGGERING A PROCESS

(71) Applicant: What Watch AG, Zurich (CH)

(72) Inventor: Igor Basargin, Yekaterinburg (RU)

(21) Appl. No.: 15/114,151

(22) PCT Filed: Jan. 27, 2014
(86) PCT No.: PCT/IB2014/058576

§ 371 Date: Jul. 26, 2016

(51) Int. Cl. G06F 9/445

(52) U.S. Cl. CPC G06F 9/445

(57) ABSTRACT

A controlling arrangement for triggering a process of a data related to an event in a communication application comprises a wrist watch. The wrist watch comprises a controlling means for outputting a triggering signal related to said event when manipulated the controlling means. The arrangement is configured to communicate said triggering signal from the wrist watch to a data processing means of the communication application, whereupon the data processing means is configured to launch said process of the data related to said event in the communication application.

### TECHNICAL FIELD OF THE INVENTION

The invention relates to a method and arrangement for triggering a process in a media, communication or diary application. Especially the invention relates to triggering a process of a data related to an event.

### BACKGROUND OF THE INVENTION

A number of media, communication or diary applications for processing, such as publishing, sharing, storing or delivering data related to an event, like photos and messages related to a special event or moment, are known from prior art. These applications may be open applications, like Facebook, Instagram or Twitter, where actually everybody may join, or these applications may be closed applications, like specially dedicated application for a certain platform. The closed applications are typically applications where only a certain closed group of people are joined, among which the data are communicated.

It is typical to the known applications that data to be processed, like a photo or message to be published, is written at the moment of the event and published at the same time. The photo and message may also be prepared beforehand and the processing can be programmed or timed so that it will be processed, like published after a certain time limit.

There are however some disadvantages relating to the known prior art, such as if exact time is needed or desired for the processing the data. Many events or moments are by the nature very fast or short, momentary, which makes it very challenging or even impossible to process the data exactly at the moment when it happens. Sometimes the event might be so exiting or dangerous that it is in practice impossible or unthinkable for anybody to concentrate to provide for example a message related to the event.

### SUMMARY OF THE INVENTION

An object of the invention is to alleviate and eliminate the problems relating to the known prior art. Especially the object of the invention is to provide an arrangement for triggering a process of a data related to an event very easily so that data, such as messages, photos, videos or the like, can be linked exactly to the moment of the event.

The object of the invention can be achieved by the features of independent claims.

The invention relates to an arrangement for triggering a process of a data related to an event according to claim 1. In addition the invention relates to a wrist watch according to claim 15, a method according to claim 16, and a computer program product according to claim 27.

According to an embodiment of the invention a controlling arrangement, as well as also a method, for triggering a process of a data related to an event comprises a wrist watch, which comprises a controlling means for outputting a triggering signal related to said event when manipulated the controlling means. The process may be for example publishing or storing or in other way manipulating a data, like message, image, video or link in a media, communication or diary application (hereinafter application or communication application). The event may be any event happened or other way related to the user, such as event related to work, leisure time, hobby, or other situations in life, like a birth of a baby or first jump by a parachute, or any unexpected event, such as an accident or incidence. It is to be noted that the triggering of the process launches the process, for example sets a time stamp for the event, whereupon the data related to the event can be added and published, stored or otherwise processed afterwards.

According to an example, in order to take the application or wrist watch in use, the application or wrist watch must be activated for example by inputting a serial number of the application or wrist watch and/or by creating an account or profile to the application. It is to be noted that the account or profile may comprise open portions, which can be shared for example to other people belonging to the same group in the application, or the account or profile may comprise closed or confidential portions, which are not open for anybody than the owner (like a confidential diary).

The controlling means may be for example a special button, e.g. so called stop button or touch sensor of the wrist watch, which captures a time (time stamp) when pressed or other way manipulated. According to an example time of the wrist watch or other related device is “stopped” at the moment of the event and captured for the processing of the data. According to exemplary embodiments the controlling means may also be other type of controlling means, such as G-force sensor, GPS or other location sensing means, altimeter or barometer, temperature sensor or speed indicator as an example, which is capable of outputting said triggering signal related to said event, when manipulated the controlling means, such as when the button is pressed, or parameter determined by the controlling means exceeds or deceeds a certain predetermined limit or value. It is to be understood that these controlling means are only examples and also other type of sensors suitable for measuring physical quantities from the environment is possible to use as said controlling means, such as or physiological signal measuring device, for example heart rate monitor or blood pressure monitor.

When the controlling means is manipulated, it outputs said triggering signal, which (or other signal due to triggering signal) is communicated from the wrist watch to a data processing means of the communication application at a network server, for example, whereupon the data processing means is configured to launch said process of the data related to the event in said communication application. It is to be noted that the triggering signal may be communicated to the data processing means by the wrist watch or an auxiliary communication means, advantageously a mobile device (later a mobile device), may be used between the wrist watch and the data processing means, which is capable of receiving said triggering signal from the wrist watch and again transferring it to said data processing means. Again it is to be noted that said data processing means may be comprised by said auxiliary communication means, like the mobile phone, or the data processing means may be at a cloud server, for example, depending on the communication application for processing said data.

The mobile device may be for example a mobile station, smart phone, computer or tablet computer with suitable hardware and software needed for a communication with a mobile network and the wrist watch. According to an embodiment the mobile device comprises the communication application or at least suitable user interface to said communication application, via which the user can compose for example the messages to be processed as a result of the triggering signal provided by the wrist watch. According to an example the application may be in a data communication with other applications located at the other user related devices (e.g. friend's devices, such as the wrist watches) via a communication application server located at a data network. For the bidirectional communication the user related device is advantageously arranged in a bidirectional data communication connection with the communication application or network server hosting the communication application environment.

According to an embodiment the mobile device communicates at least portion of the data to be processed to the data processing means of the communication application when triggering signal is provided. As an example, when the controlling means is manipulated, for example a so called stop button is pressed at the wrist watch, the triggering signal, comprising advantageously a time stamp, is transmitted by the wrist watch to the mobile device, which may send it to the data processing means. According to an example the data, like photos and messages, related to the event may be produced after the event and coupled afterwards to the time stamp of the event. The data can be produced by the mobile device, but according to the example at least portion of the data to the process may also be provided by other device. For example, if the time stamp and message is send by the mobile device to the cloud server, additional data, like video or images, can be added afterwards related to the same event for example by computer being connected to said cloud server and having access to said process of the data related to said event.

According to another exemplary embodiment at least portion of the data to be processed may also be provided before the event and stored in a memory means. The memory means may be memory means of the mobile device or the communication application (such as an account at the communication application server at the network), or other memory means of any external server being in data communication with the communication application. In this example the user typically has some knowledge about a coming event. He might know e.g. that he is jumping with a parachute, whereupon he can write a message before the event and store it to the memory means. Then, when manipulating the controlling means (like pressing the stop button or sensing zero gravity by the G-force sensor for a certain time), the triggering signal is output, whereupon the processing means of the application processes said data related to said event, like publish the message written beforehand in the communication application.

It is to be noted that a time limit estimation for the assumed event to be happened may be provided to the wrist watch before the event, whereupon the wrist watch advantageously provides a reminder or indicator, such as an alarm or visual indication on its display of the assumed event to be happened. The time limit estimation may be communicated to the wrist watch by the communication application or mobile device, for example.

Still according to an embodiment also location data of the wrist watch or mobile device can be added when manipulating said controlling means of the wrist watch.

In addition, according to an exemplary embodiment at least two controlling means may be used, which means that in order to provide the triggering signal related to said event, the parameters by both of the controlling means must fulfil a certain predetermined condition. For example the stop button sends the triggering signal only if the wrist watch is within a certain GPS-location or other predetermined parameter requirement is fulfilled.

Furthermore, according to an example the event can be created to the application or profile in the application also afterwards e.g. via the application or its user interface. For example when the user is creating his account or profile, event already happened in the past can be added and data related to these events can be processed, like added, shared, etc.

Again, according to an embodiment symbols related to the events managed by the application can be shown or displayed in the display means of the wrist watch. The layout or the user interface of the applications may for example have a certain symbol, like a bar or circle, like coloured circle, denoting one or more event. When there is plurality of event in the user's account, the display of the wrist watch (or account) will become personalised thereby expressing the activity of the user (more the symbols, more active the user). The location of the signs in the display may be chosen freely, but according to an embodiment event happened in a certain month is shown in a certain sector dedicated for that month, etc. Anyway, according to an exemplary embodiment this option for modifying the expression of the display is available only for manufacturer od the wrist watch, but naturally this can be broaden also for other ends, such as the end user or application manufacturer. According to an example the view of the current display can be “frozen” and/or stored in the memory means for example of the user related device, wrist watch or other external system, whereupon it can be restored, viewed or used as a screen saver or the like and thus additionally expressing the activity of the user.

The invention offers many advantages over the known prior art, such as offers essentially complete freedom for the user to enjoy at the moment of the event and still capturing or performing a certain acts related to said event without any massive demands for the users.

### BRIEF DESCRIPTION OF THE DRAWINGS

Next the invention will be described in greater detail with reference to exemplary embodiments in accordance with the accompanying drawings, in which:

FIG. 1 illustrates a principle of an exemplary arrangement for triggering a process of a data related to an event according to an advantageous embodiment of the invention.

### DETAILED DESCRIPTION

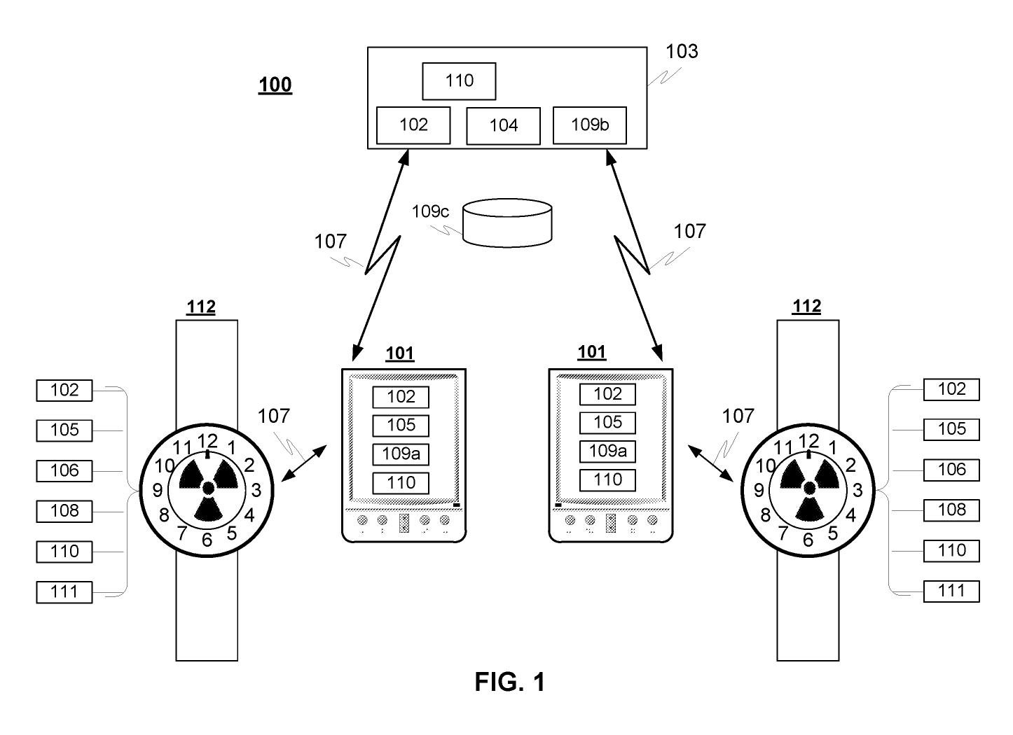

FIG. 1 illustrates a principle of an exemplary arrangement 100 for triggering a process of a data related to an event in a communication application 102 according to an advantageous embodiment of the invention, wherein, wherein the arrangement comprises a wrist watch 112, a mobile device 101 and advantageously an application server 103 hosting data transfer advantageously between the mobile devices 101 (their communication applications) and again the wrist watches 112 in the arrangement. It is to be noted that according to an embodiment the mobile device 101 is optional and the data communication may be performed directly between application server 103 the wrist watch 112.

According to an embodiment the application server 103 may also host at least portion of the communication application 102 and comprise also suitable data processing means 104 for processing data. However, it is to be noted that also the mobile device 101 may comprise at least portion of said communication application 102 or at least suitable user interface means to said communication application 102. In addition the mobile device may also comprise suitable data processing means 105 for processing data. In addition, it is to be noted that according to an embodiment also the wrist watch 112 may comprise at least portion of said communication application 102 or at least suitable user interface means to said communication application 102 or suitable data processing means 105.

The wrist watch 112 comprises at least one controlling means 106 for outputting a triggering signal related to the event, when the controlling means is manipulated. The controlling means may be for example a special dedicated button, such as a so called stop button, or a sensor configured to detect a certain measurable environmental quantity, as is disclosed elsewhere in this document.

When the controlling means 106 is manipulated, it triggers a signal, which is advantageously communicate to the data processing means 104 (or optionally at least partially to 106) of the communication application via the mobile device 101. The data processing means 104, 106 is then configured to launch the process of the data related to the event in the communication application.

When the mobile device 101 is utilized, the wrist watch 112 and the mobile device 101 are arranged in a data communication with each other via suitable data communication means, such as Bluetooth, Zigbee, WLAN, 3G or 4G connection or other connection technologies known by the skilled person. The data communication is advantageously a bidirectional data communication 107. The data communication and application server 103 are advantageously configured to enabling also data transfer between the communication applications of the different mobile devices 101 and possibly also the wrist watches 112 in the arrangement.

In addition the arrangement comprises a memory means for storing the data to be processed. The memory means may be memory means 109a of the mobile device, memory means 109b of the communication application server, or other memory means 109c of any external server being in data communication with the communication application. Of course it is to be understood that also the wrist watch may comprise a memory means.

The wrist watch 112 and/or mobile device 101 comprises also advantageously a timing means 110, which is configured to provide a time stamp when the controlling means is manipulated and the triggering signal is output. Timing means may be an internal timer or timing information may be received from an external source, such as from a data network. It is to be noted that the timing means 110 may also be utilized at the application server 102, where it is configured to provide the time stamp when receiving said triggering signal.

The wrist watch 112 may also comprise a positioning means 111, such as a GPS or cellular based positioning system, which is configured to provide location data of the wrist watch for example when the controlling means of the wrist watch is manipulated. The location data can also be sent to the application server and related to the event or data to be processed.

As discussed elsewhere in this document, the wrist watch may comprise at least two different controlling means for detecting different quantities, whereupon the wrist watch may be configured to output the triggering signal related to said event only when parameters detected by both of the controlling means are in a certain predetermined limit. For example the pressing of the stop button sends the triggering signal only if the wrist watch is within a certain GPS-location or when another parameter of another controlling means matches to a predetermined value or range.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

According to an example the wrist watch or application (implemented for example by a software) may be bought for example as a gift, whereupon the gift giver may create a profile and history to the account related to the device (or user) of the events already passed, and thereby share e.g. the common moments of their life with the gift receiver. Of course also upcoming events can be created beforehand, correspondingly as has been disclosed in this document elsewhere. It is to be that at least part of the accounts or profiles may be common (copied or shared) for two or more users, such as for a couple, whereupon they both can share data related to e.g. their first dating, first travelling or any other common moments lived together. Again it is to be noted that at least portion of the accounts or profiles may be denoted as a confidential or personal, whereupon that part is managed as a personal diary and that data is available only to the user of the device.

1. A controlling arrangement for triggering a processing of data related to an event in a communication application, the arrangement comprising:
a wrist watch comprising a control configured for outputting a triggering signal related to said event when the control is activated; and
a communicator configured to communicate said triggering signal from the wrist watch to a data processor having the communication application, whereupon the data processor is configured to launch said processing of the data related to said event in the communication application.

2. A controlling arrangement of claim 1, further comprising:
an auxiliary communicator in data communication with the wrist watch, the auxiliary communicator being in data communication with the data processor of the communication application.

3. A controlling arrangement of claim 2, wherein the auxiliary communicator is configured to communicate at least a portion of said data to be processed from the wrist watch to the data processor of the communication application in addition to said triggering signal.

4. A controlling arrangement of claim 1, further comprising:
an auxiliary communicator memory in which is stored at least a portion of said data related to said event, wherein the at least the portion of the data is produced before the event, whereupon when outputting said triggering signal, the data processor of the communication application is configured to process said data related to said event in the communication application.

5. A controlling arrangement of claim 4, wherein a time limit estimation for an event that is assumed will happen is provided to said wrist watch before the event, whereupon said wrist watch is configured to provide a reminder or indicator of the event that is assumed will happen.

6. A controlling arrangement of claim 1, wherein the controlling arrangement is configured to provide a time stamp of the event for the data processor of the communication application, when outputting said triggering signal.

7. A controlling arrangement of claim 6, wherein at least a portion of said data related to said event is produced after the event and coupled to said time stamp.

8. A controlling arrangement of claim 2, wherein the wrist watch comprises a data communicator configured and operable for communicating data to at least one of the data processor of the communication application or to the auxiliary communicator.

9. A controlling arrangement of claim 2, wherein the controlling arrangement is configured to provide location data of one of the wrist watch or the auxiliary communicator while in communication with said wrist watch when the control of the wrist watch is activated.

10. A controlling arrangement of claim 1, wherein the control is a control device selected from the group consisting of: a button, G-force sensor, GPS receiver, altimeter barometer, temperature sensor, speed indicator, and physiological signal measuring device configured for outputting said triggering signal related to said event, the control being activated when the control device is pressed or a parameter passes a predetermined threshold.

11. A controlling arrangement of claim 1, wherein the control includes at least two controls, whereupon the wrist watch is configured for outputting said triggering signal related to said event when parameters detected by both of the at least two controls pass respective predetermined thresholds.

12. A controlling arrangement of claim 1, wherein the processing of the data includes processing one of a text message, image, video, or link to a data content.

13. A controlling arrangement of claim 1, wherein the controlling arrangement is configured to provide a profile for the events of a user, and wherein the controlling arrangement is configured to add events that have passed to the profile.

14. A controlling arrangement of claim 1, wherein the wrist watch comprises a display, and wherein the wrist watch is configured to display a symbol related to each event on the display.

15. (canceled)

16. A method for triggering processing of data related to an event in a communication application, the method comprising:
receiving an activation of a control of a wrist watch;
outputting a triggering signal related to said event upon activation of the control:
communicating said triggering signal from the wrist watch to a data processor of the communication application; and
launching processing of the data related to said event in the communication application.

17. A method claim 16, wherein the wrist watch is in a data communication with an auxiliary communicator, and wherein the auxiliary communicator is in a data communication with the data processor of the communication application.

18. A method claim 17, wherein the auxiliary communicator communicates at least portion of the data to be processed to the data processor of the communication application in addition to said triggering signal.

19. A method of claim 16, wherein at least a portion of said data related to said event is produced before the event and stored in a memory of an auxiliary communicator, whereupon when outputting said triggering signal, the processor of the communication application processes said data related to said event in the communication application.

20. A method claim 19, further comprising:
providing an estimate of a time for an event that is assumed will happen to said wrist watch before the event; and
outputting from said wrist watch a reminder or indicator of the event that is assumed will happen.

21. A method of claim 16; further comprising:
providing a time stamp of the event for the processor of the communication application when outputting said triggering signal.

22. A method of claim 21, wherein at least portion of said data related to said event is produced after the event and coupled to said time stamp.

23. A method of claim 17, further comprising:
communicating location data of one of the wrist watch or the auxiliary communicator when the control is activated, the auxiliary communicator being in communication with said wrist watch.

24. A method of claim 16, further comprising:
outputting said triggering signal related to said event when parameters detected by at least two different controls pass respective predetermined thresholds.

25. A method of claim 16, wherein the communication application is one of an open or closed application.

26. A method of claim 16, wherein the data to be processed is one of a text message, image, video, or link to a data content.

27. A computer program product for triggering processing of data related to an event in a communication application, comprising:
program code stored on a computer-readable medium, the program code being executable on a processor to perform the steps of:
receiving an activation of a control of a wrist watch;
outputting a triggering signal related to said event upon activation of the control:
communicating said triggering signal from the wrist watch to a data processing apparatus of the communication application; and
launching processing of the data related to said event in the communication application;
the program code being at least partially executed in at least one of a wrist watch, an auxiliary communicator and a processor of the communication application.
